(19) United States
(12) Patent Application Publication
(10) Pub. No.: US 2006/0044824 A1
(43) Pub. Date: Mar. 2, 2006

(54) Soft warning strip

(76) Inventor: Yung-Hwa Chen, Yung Ho-city (TW)

Correspondence Address: BIRCH STEWART KOLASCH & BIRCH, PO BOX 747, FALLS CHURCH, VA, 22040-0747, US

(21) Appl. No.: 10/923,857

(22) Filed: Aug. 24, 2004

(51) Int. Cl. F21V 7/04

(52) U.S. Cl. 362/583; 362/551; 362/555; 362/293

(57) ABSTRACT

A soft warning strip comprising a luminous element, a soft luminous strip and a cover can be installed on the surface of many articles with warning function; the cover wraps the soft luminous strip externally, several printed reflective spots are on the surface of the cover; the luminous element is installed on one or both sides of the soft luminous strip. The luminous element emits light into the soft luminous strip; the reflective spots on the cover reflect the light to have the soft luminous strip glows without reflection from external light sources.

### BACKGROUND OF THE INVENTION

I. Field of the Invention

This invention relates generally to a warning and, more specifically, to a soft warning strip that emits warning light.

II. Description of the Prior Art

Heretofore, it is known that warning strip is to warn and remind people around for more attention in certain circumstances, such as in the construction areas, traffic signals, the uniforms of hazardous working personnel or the back of the moving vehicles. The warning strip applies self-luminous or reflective ways; the present invention is about the self-luminous warning strip. Referring to FIG. 1, the known warning strip has a plurality luminous elements install in a shell body, a transparent cover with different colors is on the front of the shell body, the transparent cover can be in long tripe, square, round or irregular shape, the luminous element emits light toward transparent cover for different colors to warn; however for firm and solid purpose, the shell bodies usually are made from stiff materials, such as metal and plastic, such will not only increases manufacturing cost but also cannot apply in many circumstances flexibly and stably, such as the uniforms of working personnel and the moving vehicles.

### SUMMARY OF THE INVENTION

It is therefore a primary object of the invention to provide a soft warning strip that applies self-luminous method and is very convenient to be used in different circumstances.

In order to achieve the objective set forth, a soft warning strip in accordance with the present invention comprises a luminous element, a soft luminous strip and a cover. The cover wraps the soft luminous strip externally, several printed reflective spots are on the surface of the cover; the luminous element is installed on one or both sides of the soft luminous strip.

While application based on structure described above, the luminous element emits light into the soft luminous strip; the reflective spots on the cover reflect the light to have the soft luminous strip glows without reflection from external light sources. The design of the soft luminous strip can be stitched or stuck on surface of many articles directly, such as clothes, the brim of hats, handbags, sacks and various irregular substances, the present invention is more convenient and widely applied.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

FIG. 2 is an assembly view of the present invention;

FIG. 3 is a perspective view of the present invention;

FIG. 4A is an application view of a further embodiment of the present invention;

FIG. 4B is another application view of a further embodiment of the present invention;

FIG. 5 is a perspective view of a further embodiment of the present invention;

FIG. 6A is a pattern of a further embodiment of the present invention;

FIG. 6B is another pattern of a further embodiment of the present invention;

FIG. 6C is a third pattern of a further embodiment of the present invention.

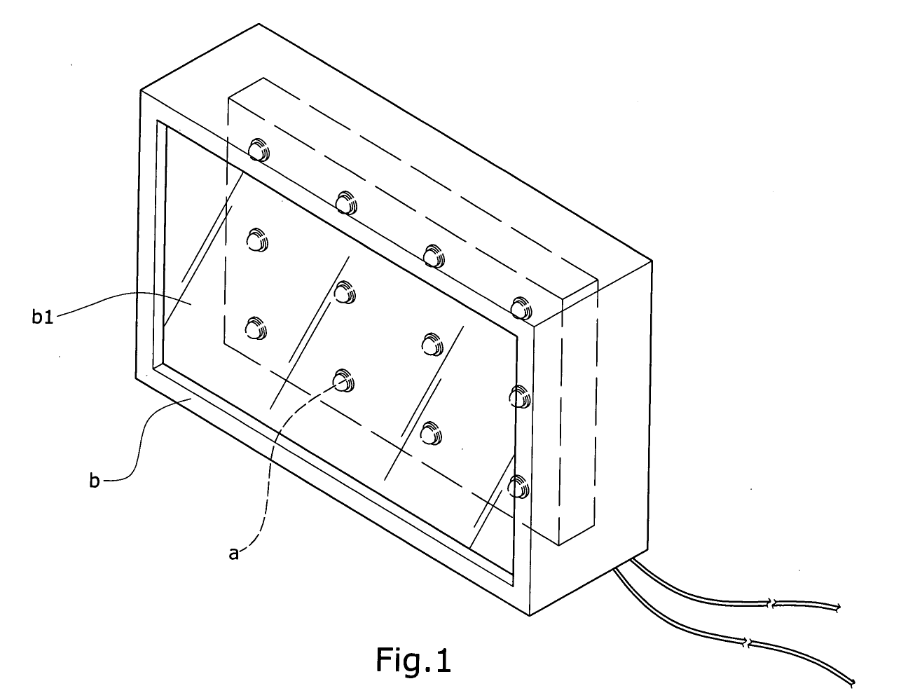

### DESCRIPTION OF THE PREFERRED EMBODIMENT

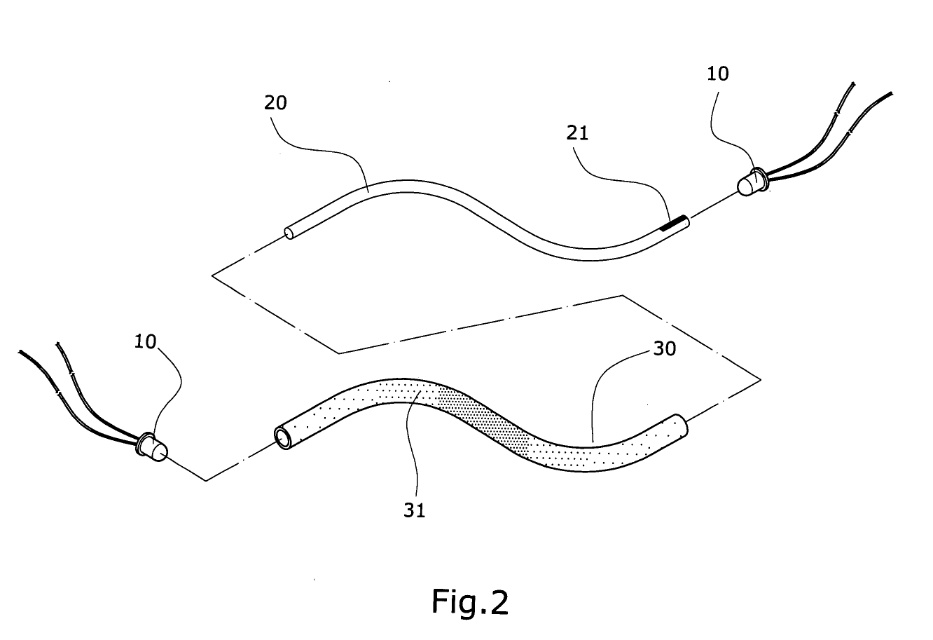

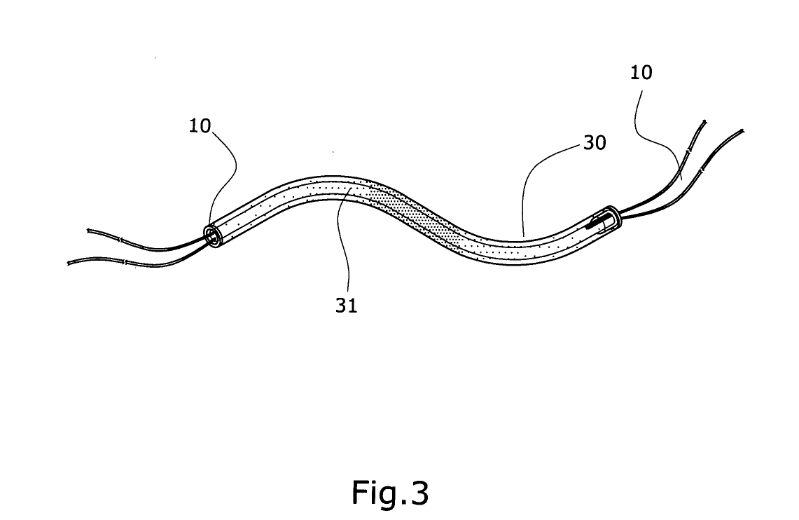

Referring to FIG. 2 and FIG. 3, the present invention comprises a luminous element 10, a soft luminous strip 20 and a cover 30. The function of each component is described as following:

The luminous element 10 is LED (Light Emitting Diode) or light bulb to emit light in different colors, such as red, yellow, blue, green and white; the luminous element 10 is installed on one or both sides of the soft luminous strip 20.

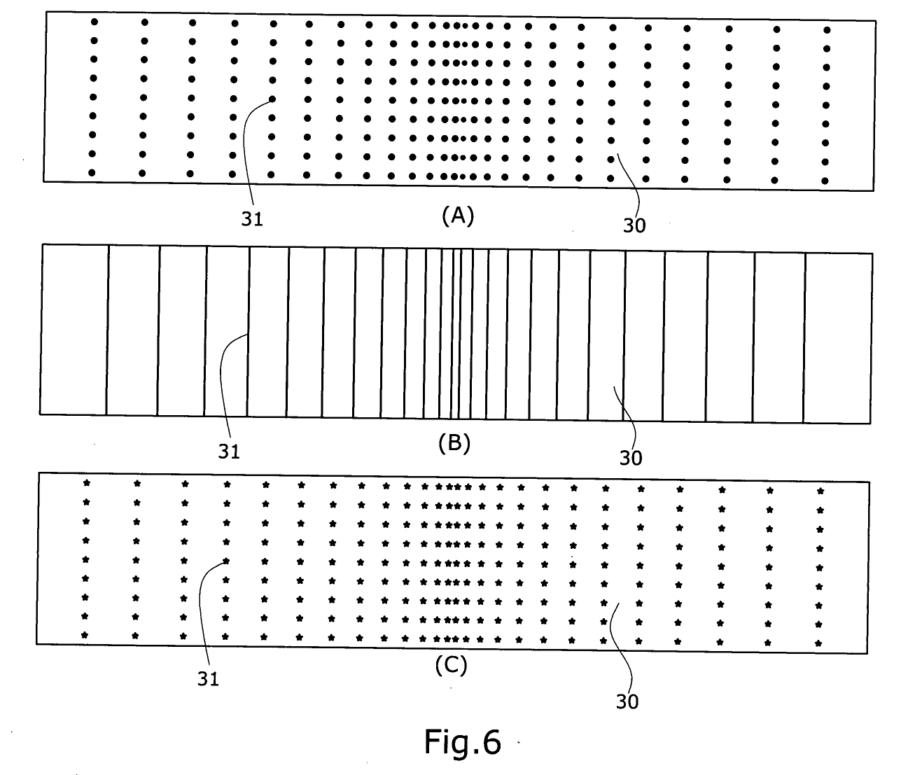

The soft luminous strip 20 is made of soft, transparent rubber in long strip or slice shape; the cover 30 wraps the soft luminous strip 20 externally, several printed reflective spots 31 are on the surface of the cover 30, the cover 30 is made of transparent plastic without color, the reflective spots 31 are in round, long strip or other irregular patterns (as shown in FIG. 6A, FIG. 6B and FIG. 6C).

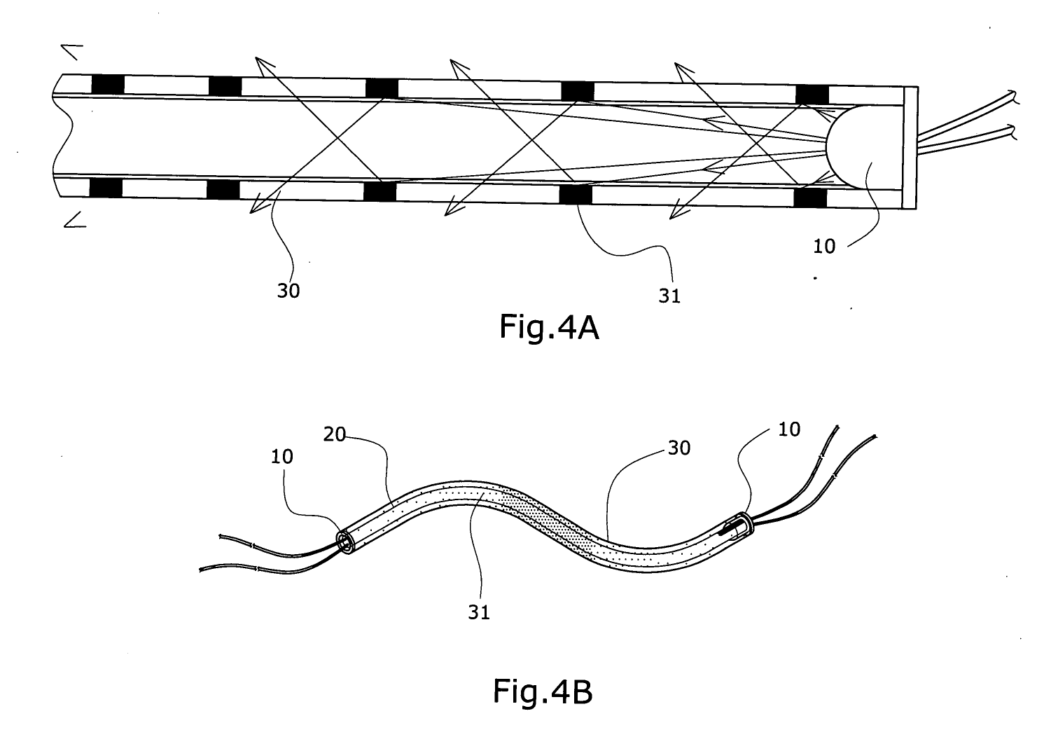

Referring to FIG. 4A and FIG. 4B, the luminous element 10 emits light into the soft luminous strip 20; the reflective spots 31 on the cover 30 reflect the light to have the warning strip 1 glow.

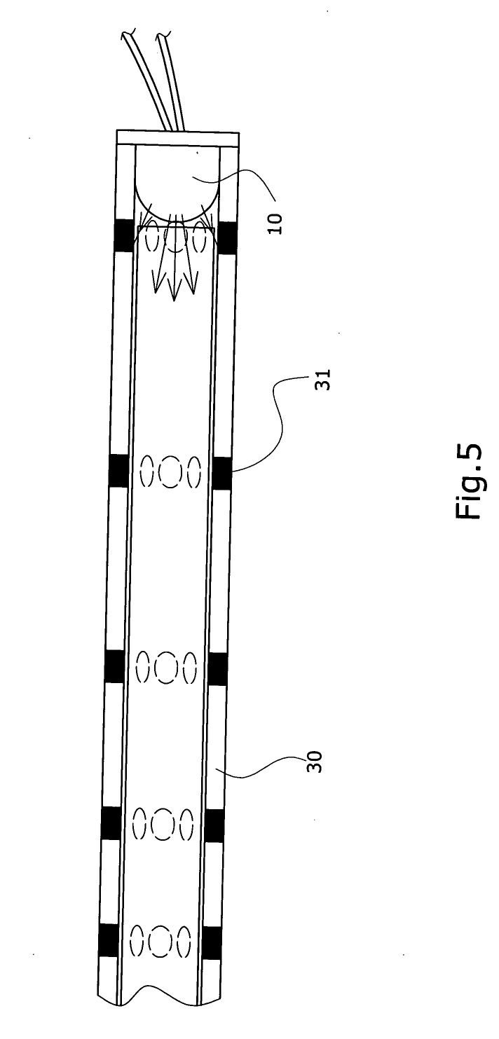

Referring to FIG. 5, the farther of the reflective spots 31 on the cover 30 away from the luminous element 10, the denser of the reflective spots 31 are distributed on the cover 30, the light reflected inside the soft luminous strip 20 is distributed evenly over the soft luminous strip 20 without over-concentration.

While a preferred embodiment of the invention has been shown and described in detail, it will be readily understood and appreciated that numerous omissions, changes and additions may be made without departing from the spirit and scope of the invention.

What is claimed is:

1. A soft warning strip comprising:
a luminous element, a soft luminous strip and a cover to be installed on the surface of all articles and has warning luminance, said cover wraps said soft luminous strip externally, several printed reflective spots are on the surface of said cover, said luminous element is installed on one side of said soft luminous strip.

2. The soft warning strip recited in claim 1, wherein said luminous element is installed on both sides of said soft luminous strip.

3. The soft warning strip recited in claim 1, wherein said luminous element is LED.

4. The soft warning strip recited in claim 1, wherein said luminous element is light bulb.

5. The soft warning strip recited in claim 1, wherein said luminous element emits red light.

6. The soft warning strip recited in claim 1, wherein said luminous element emits yellow light.

7. The soft warning strip recited in claim 1, wherein said luminous element emits blue light.

8. The soft warning strip recited in claim 1, wherein said luminous element emits green light.

9. The soft warning strip recited in claim 1, wherein said luminous element emits white light.

10. The soft warning strip recited in claim 1, wherein said soft luminous strip is made of soft, transparent rubber.

11. The soft warning strip recited in claim 1, wherein said soft luminous strip is in long strip shape.

12. The soft warning strip recited in claim 1, wherein said soft luminous strip is in slice shape.

13. The soft warning strip recited in claim 1, wherein said cover is made of transparent plastic without color.

14. The soft warning strip recited in claim 1, wherein said reflective spots are in round pattern.

15. The soft warning strip recited in claim 1, wherein the reflective spots are in long strip pattern.

16. The soft warning strip recited in claim 1, wherein the reflective spots are in irregular pattern.

17. The soft warning strip recited in claim 1, wherein the farther of said reflective spots on said cover away from said luminous element, the denser of said reflective spots are distributed on said cover.
